(19) United States
(12) Patent Application Publication
(10) Pub. No.: US 2026/0065237 A1
(43) Pub. Date: Mar. 5, 2026

(54) AUTOMATED VIRAL CONTENT DETECTION

(71) Applicant: American Express Travel Related Services Company, Inc., New York, NY (US)

(72) Inventors: Jianqiu Chen, Jersey City, NJ (US); Bomnae Hur, New York, NY (US); Suraj Madnani, River Edge, NJ (US); Ravi Varma, White Plains, NY (US)

(21) Appl. No.: 18/817,874

(22) Filed: Aug. 28, 2024

(51) Int. Cl. G06Q 50/00; G06N 20/00; G06Q 30/0282

(52) U.S. Cl. CPC G06Q 10/40; G06N 20/00; G06Q 30/0282

(57) ABSTRACT

A computing device can determine a negative sentiment score based at least in part on user posts to a social media platform within a predefined interval of time. Then, the computing device can compare the negative sentiment score to a moving average sentiment score to determine whether the negative sentiment score exceeds a threshold value based at least in part on the moving average sentiment score. The computing device can then generate an alert in response to a determination that the negative sentiment score exceeds the moving average sentiment score by the predefined amount. Finally, the alert can be formatted according to a recipient defined format and transmitted to a client device, thereby activating a client application to cause the client application to display the alert and enable the client device to connect to the computing device to view additional information about the alert.

### BACKGROUND

On social media platforms, awareness of topics or issues can suddenly increase at an exponential rate as users submit and share posts or other user content. This phenomenon is often referred to as “going viral.” Due to the speed at which users are able to share content with other users on social media platforms, awareness of a topic or issue can spread rapidly to a large number of users before the subject of the topic or issue becomes aware of its existence on social media.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing depicting one of several embodiments of the present disclosure.

FIG. 2 is a drawing of a network environment according to various embodiments of the present disclosure.

FIG. 3 is a flowchart illustrating one example of functionality implemented as portions of an aggregator application executed in a computing environment in the network environment of FIG. 2 according to various embodiments of the present disclosure. Alternatively, the flowchart of FIG. 3 could be viewed as a method implemented within the network environment of FIG. 2 according to various embodiments of the present disclosure.

FIG. 4 is a flowchart illustrating one example of functionality implemented as portions of a content analysis application executed in a computing environment in the network environment of FIG. 2 according to various embodiments of the present disclosure. Alternatively, the flowchart of FIG. 4 could be viewed as a method implemented within the network environment of FIG. 2 according to various embodiments of the present disclosure.

FIG. 5 is a flowchart illustrating one example of functionality implemented as portions of a content analysis application executed in a computing environment in the network environment of FIG. 2 according to various embodiments of the present disclosure. Alternatively, the flowchart of FIG. 5 could be viewed as a method implemented within the network environment of FIG. 2 according to various embodiments of the present disclosure.

### DETAILED DESCRIPTION

Disclosed are various approaches for identifying and detecting potential reputational crises as they occur on social media platforms. User content submitted to a social media platform is analyzed at predefined intervals of time. User content having a negative sentiment towards an entity is identified and used to calculate a negative sentiment score. Changes in the negative sentiment score over time can be used to identify topics or issues with a negative sentiment towards the entity as awareness of the topics or issues begin to spread on the social media platform.

In the following discussion, a general description of the system and its components is provided, followed by a discussion of the operation of the same. Although the following discussion provides illustrative examples of the operation of various components of the present disclosure, the use of the following illustrative examples does not exclude other implementations that are consistent with the principals disclosed by the following illustrative examples.

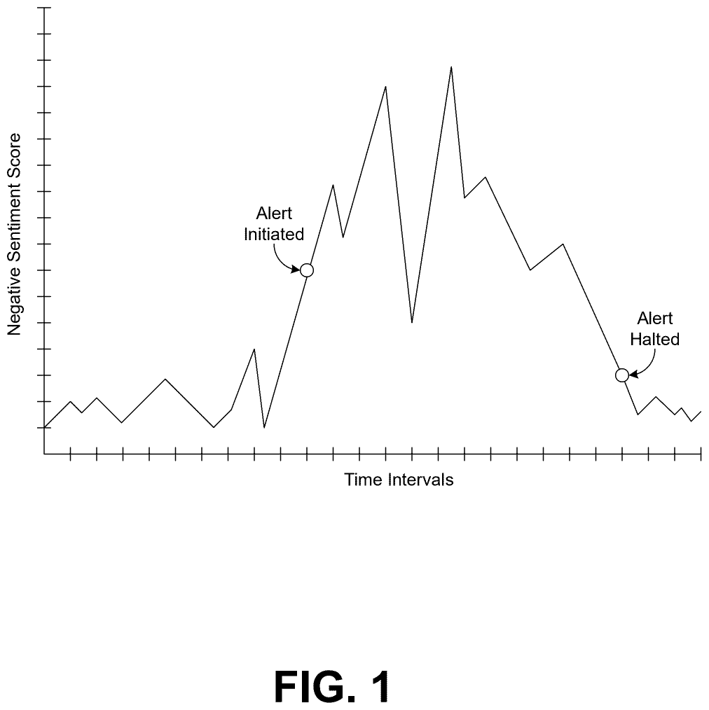

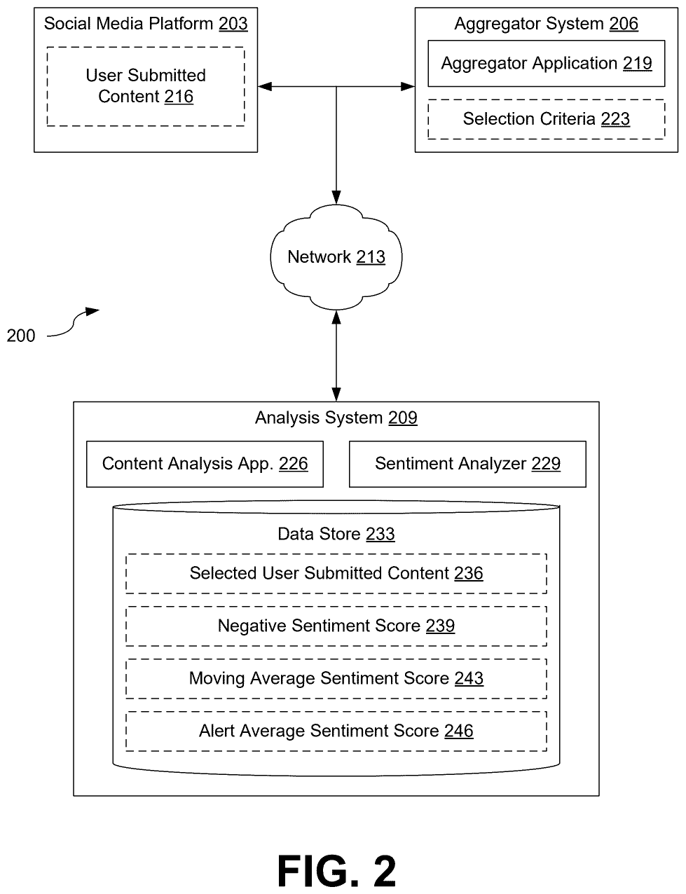

FIG. 1 provides a conceptual illustration of the various embodiments of the present disclosure. A negative sentiment score is tracked at regular time intervals. The negative sentiment score, described in further detail in the subsequent discussion of FIG. 2, measures the negative sentiment of user content on a social media platform with respect to a particular individual, organization, or other entity. When sudden increases in the negative sentiment score are detected, an alert is initiated or triggered so that the individual, organization, or other entity can become aware of the emerging reputational crisis. When the negative sentiment score returns to the historical range, this indicates that reputational crisis has based and that the alert can be halted.

With reference to FIG. 2, shown is a network environment 200 according to various embodiments. The network environment 200 can include a social media platform 203, an aggregator system 206, and an analysis system 209, which can be in data communication with each other via a network 213.

The network 213 can include wide area networks (WANs), local area networks (LANs), personal area networks (PANs), or a combination thereof. These networks can include wired or wireless components or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (i.e., WI-FI®), BLUETOOTH® networks, microwave transmission networks, as well as other networks relying on radio broadcasts. The network 213 can also include a combination of two or more networks 213. Examples of networks 213 can include the Internet, intranets, extranets, virtual private networks (VPNs), and similar networks.

The computing environment social media platform 203, aggregator system 206, and/or the analysis system 209 can each include one or more computing devices that include a processor, a memory, and/or a network interface. For example, the computing devices can be configured to perform computations on behalf of other computing devices or applications. As another example, such computing devices can host and/or provide content to other computing devices in response to requests for content.

Moreover, the social media platform 203, aggregator system 206, and/or the analysis system 209 can employ a plurality of computing devices that can be arranged in one or more server banks or computer banks or other arrangements. Such computing devices can be located in a single installation or can be distributed among many different geographical locations. For example, the social media platform 203, aggregator system 206, and/or the analysis system 209 can include a plurality of computing devices that together can include a hosted computing resource, a grid computing resource or any other distributed computing arrangement. In some cases, the social media platform 203, aggregator system 206, and/or the analysis system 209 can correspond to an elastic computing resource where the allotted capacity of processing, network, storage, or other computing-related resources can vary over time.

The social media platform 203 can represent one or more interactive applications or computer-mediated networks that facilitate the creation or sharing of information or opinions via virtual communities and networks. The social media platform 203 can provide web-based applications that can accessed through a browser on a user's personal computer or mobile device or standalone applications that can provide access to the social media platform 203 when executed on a user's personal computer or mobile device. Examples of social media platforms 203 include TWITTER®, FACEBOOK®, INSTAGRAM®, LINKEDIN®, TIKTOK®, TUMBLR®, REDDIT®, QUORA®, WECHAT®, WEIBO®, etc.

User submitted content 216 is content submitted to the social media platform 203 by a user for public, limited, or private consumption. Examples of user submitted content 216 include “tweets” on TWITTER® or “posts” on FACEBOOK®, INSTAGRAM®, TIKTOK®, or other platforms. User submitted content 216 can include text, uniform resource locators (URLs), images, videos, audio, etc. Social media platforms 203 may also provide for other users to rate user submitted content 216, which may be referred to as “likes” or “upvotes” by various social media platforms 203. Moreover, social media platforms 203 can also provide for users to submit their own user submitted content 216 in response to other user submitted content 216, which may be referred to as “replies” or “responses” by various social media platforms 203.

The aggregator system 206 can host an aggregator application 219. Additional data may be stored by the aggregator system 206 for use by the aggregator application 219, such as one or more selection criteria 223. Although the aggregator system 206 is depicted as being separate from the analysis system 209, and operated by a separate entity, the aggregator system 206 and the analysis system 209 could be implemented as a single system or operated and controlled by the same entity.

The aggregator application 219 can be executed to obtain all user submitted content 216 on a social media platform at predefined intervals and identify those individual instances of user submitted content 216 that satisfy one or more selection criteria 223. For example, the aggregator application 219 could be configured to obtain all user submitted content 216 on a social media platform 203 every ten minutes, every thirty minutes, every hour, every three hours, every day, or at any other predefined interval of time. The aggregator application 219 could then identify those individual instances of user submitted content 216 that match one or more of the selection criteria 223, and provide those instances of user submitted content 216 to the analysis system 209 and/or the content analysis application 226.

Selection criteria 223 can represent one or more prespecified or predefined criteria that can be used to identify instances of user submitted content 216 to be processed by the content analysis application 226. For example, selection criteria 223 could include one or more text strings for the aggregator application 219 to search for within individual instances the user submitted content 216. These text strings could be used to identify usernames (e.g., TWITTER® handles, etc.), metadata tags (e.g., hashtags or other user-generated tags that enable cross-referencing of user submitted content 216), or discussion of a topic within the instance of the user submitted content 216. For instance, the selection criteria 223 “CompanyA” could be used to identify user submitted content 216 (e.g., Tweets on Twitter) that includes the username “@companya” or a hashtag that includes the text “companya”(e.g., “#goodbyecompanya”).

The analysis system 209 can host a content analysis application 226 and a sentiment analyzer 229, among other applications. These applications can be used to determine whether an issue or a topic discussed on the social media platform 203 is increasing in visibility or awareness (e.g., “going viral”). The analysis system 209 can further use data stored in the data store 233 when executing the content analysis application 226 or the sentiment analyzer 229.

The data store 233 can be representative of a plurality of data stores 233, which can include relational databases or non-relational databases such as object-oriented databases, hierarchical databases, hash tables or similar key-value data stores, as well as other data storage applications or data structures. Moreover, combinations of these databases, data storage applications, and/or data structures may be used together to provide a single, logical, data store. The data stored in the data store 233 is associated with the operation of the various applications or functional entities described below. This data can include selected user submitted content 236, a negative sentiment score 239, a moving average sentiment score 243, an alert average sentiment score 246, and potentially other data.

The content analysis application 226 can be executed to calculate a current negative sentiment score 239 at periodic intervals, based on the sentiments of individual ones of the selected user submitted posts 236. The content analysis application 226 can then compare the current negative sentiment score 239 to a moving average sentiment score 243 to determine whether an issue or a topic discussed on the social media platform 203 is increasing in visibility or awareness (e.g., “going viral”). The content analysis application 226 can also update the moving average sentiment score 243 at periodic intervals of time based at least in part on the negative sentiment score 239 calculated by the content analysis application 226.

The sentiment analyzer 229 can be executed to identify the sentiment of individual ones of the selected user submitted content 236. The sentiment analyzer 229 can use any sentiment analysis technique. However, because instances of selected user submitted content 236 are likely to be brief (e.g., less than 140 characters), sentiment analysis techniques that use machine-learning models trained on short samples of text may be preferred in some implementations.

For example, the sentiment analyzer 229 could be trained on a corpus of content, such as reviews. Reviews of movies, products, services, etc., tend to be short, and are also usually associated with a numeric rating system (e.g., one to five stars, one to ten stars, etc.) that identifies how positive or negative the review is. The sentiment analyzer 229 could therefore use machine-learning to train itself to identify positive, negative, or neutral sentiments of a sample of text based at least in part on an analysis of reviews and their associated rating. Once trained, the sentiment analyzer 229 could then classify subsequently submitted instances of text as having a positive, negative, or neutral sentiment.

For example, the sentiment analyzer 229 can include one or more machine learning models generated based at least in part on one or more machine learning algorithms as applied to one or more training and/or validation data sets (e.g., data sets of reviews of movies, products, services, etc.). The one or more machine learning algorithms can include, without limitation, word2vec, recurrent neural networks (e.g., Long Short-Term Memory, etc.), recursive neural networks, convolutional neural networks and/or any other machine learning algorithms configured to identify, extract, and/or quantify sentiment associated with submitted instances of text. After the one or more machine learning models are generated, the sentiment analyzer 229 can be further configured to classify submitted instances of text as having positive, negative, or neutral sentiment or any numerical representations thereof.

The selected user submitted content 236 can represent a subset of user submitted content 216 that has been selected by the aggregator application 219 based at least in part on one or more of the selection criteria 223. In some implementations, the selected user submitted content 236 may be stored in separate batches or groups. Each batch or group may represent the user submitted content 216 submitted to the social media platform 203 within a predefined interval or period of time. As each interval of time passes, a new subset of selected user submitted content 236 may be provided by the aggregator application 219 and stored in the data store 233.

The negative sentiment score 239 represents a weighted measure of the number of instances of the selected user submitted content 236 within a specified interval or period of time that have a negative sentiment with respect to a particular entity (e.g., a person, organization, etc.). The negative sentiment score 239 can be reflect both the number of instances of the selected user submitted content 236 that have a negative sentiment, as identified by the sentiment analyzer 229, and how often those instances are liked, shared, reposted, etc. by other users of the social media platform 203.

The moving average sentiment score 243 represents a moving average of the negative sentiment score 239 calculated by the content analysis application 226 for a preceding period of time, which may be defined according to specifications of particular implementations. For example, the moving average sentiment score 243 could represent a moving average of the negative sentiment score 239 for the preceding seven days, fourteen days, or other period of time.

The alert average sentiment score 246 represents a moving average of the sentiment score 239 during the period of time in which an alert is raised, triggered, or otherwise initiated by the content analysis application 226. The alert average sentiment score 246 can be used separately from the moving average sentiment score 243 in order to prevent the moving average sentiment score 243 from becoming skewed as a result of an issue or a topic discussed on the social media platform 203 increasing in visibility or awareness (e.g., “going viral”).

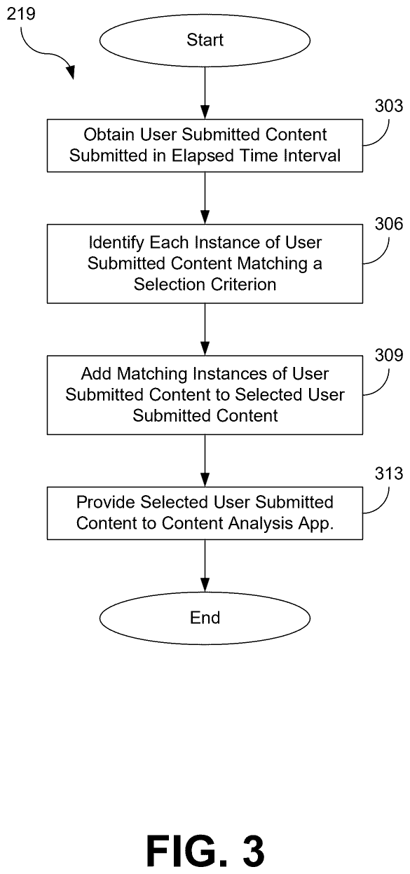

Next, a general description of the operation of the various components of the network environment 200 is provided. A more detailed description of the operation of individual components is described in further detail in the discussion of FIGS. 3-5.

To begin, users will post, upload, or otherwise provide user submitted content 216 to the social media platform 203. The user submitted content 216 can include text and media. Moreover, the user submitted content 216 can include metadata tags (e.g., hashtags) that allow individual instances of user submitted content 216 to link to or cross-reference other instances of user submitted content. Instances of user submitted content 216 can also include references to the usernames of other users of the social media platform 203 (e.g., usernames, “handles,”etc.).

At regular, predefined intervals of time, the aggregator application 219 can retrieve new or recently submitted instances of user submitted content 216. For example, the aggregator application 219 can retrieve any instances of user submitted content 216 that were added to the social media platform 203 in the interval of time since the aggregator application 219 had previously retrieved instances of user submitted content 216 from the social media platform 203. The aggregator application 219 could accomplish this, for example, by crawling a website hosted or provided by the social media platform 203 or by requesting the recently submitted instances of user submitted content 216 from the social media platform 203 through an API provided by the social media platform 203. However, the aggregator application 219 could also request or receive the data from a third-party data aggregator that crawls the website provided by the social media platform 203 or otherwise has access to the data of the social media platform 203.

The aggregator application 219 can then identify which instances of user submitted content 216 match one or more selection criteria 223 and add them to a set, list, or collection of selected user submitted content 236. For example, if a corporation were interested in monitoring user sentiment towards the corporation on the social media platform 203, then the corporation could specify a list of selection criteria 223 that included the usernames of the corporation's social media accounts, the name of the corporation itself (including common abbreviations), and any metadata tags (e.g., hashtags) known to be associated with the corporation. The aggregator application 219 could search the user submitted content 216 for all matching instances that contained a username of the corporation's social media accounts, the name of the corporation itself, or any metadata tags known to be associated with the corporation. The aggregator application 219 can then provide the selected user submitted content 236 to the content analysis application 226.

The content analysis application 226 can then store the selected user submitted content 236 in a data store 233 and begin analysis of the selected user submitted content 236. First, the content analysis application 226 can cause the sentiment analyzer 229 to identify the sentiment (e.g., positive sentiment, neutral sentiment, or negative sentiment) of each instance of the selected user submitted content 236. The content analysis application 226 can then generate a negative sentiment score 239 based at least in part on the results of the sentiment analysis. The content analysis application 226 can then compare to the negative sentiment score 239 to the moving average sentiment score 243 to determine whether an issue or a topic discussed on the social media platform 203 is increasing in visibility or awareness (e.g., “going viral”). If an issue or topic is identified as “going viral,” then an alert can be generated. Otherwise, the moving average sentiment score 243 can be updated based at least in part on the most recently calculated negative sentiment score 239.

Referring next to FIG. 3, shown is a flowchart that provides one example of the operation of a portion of the aggregator application 219. The flowchart of FIG. 3 provides merely an example of the many different types of functional arrangements that can be employed to implement the operation of the depicted portion of the aggregator application 219. As an alternative, the flowchart of FIG. 3 can be viewed as depicting an example of elements of a method implemented within the network environment 200.

Beginning with block 303, the aggregator application 219 can obtain user submitted content 216 (e.g., posts, tweets, etc.) submitted to the social media platform 203 during an elapsed interval of time. For example, the aggregator application 219 could obtain all user submitted content 216 submitted to the social media platform 203 since the previous time that the aggregator application 219 performed this process. For instance, if the aggregator application 219 obtains user submitted content 216 from the social media platform 203 every thirty minutes or other interval of time, then the aggregator application 219 could obtain or retrieve user submitted content 216 submitted to the social media platform 203 in the previous thirty minutes or other interval of time.

The aggregator application 219 could obtain the user submitted content 216 through several approaches. For example, the aggregator application 219 could invoke a function provided by an application programming interface (API) of the social media platform 203 to retrieve the user submitted content 216. The aggregator application 219 could specify a time interval as an argument to the function call in order to receive the user submitted content 216 submitted to the social media platform 203 during that time interval. As another example, the aggregator application 219 could perform a crawl of a website provided by the social media platform 203 to identify and retrieve instances of the user submitted content 216 available on the website. In some implementations, the aggregator application 219 could also receive the user submitted content 216 at regular intervals from a third-party service, which itself either crawls the website of the social media platform 203 or has direct access to the data of the social media platform 203 (including the user submitted content 216).

Then at block 306, the aggregator application 219 can identify each instance of user submitted content 216 that matches one or more predefined selection criteria 223. For example, the aggregator application 219 could perform a string or pattern matching search, such as a regular expression, to determine whether a string specified as a selection criterion 223 appears in an individual instance of user submitted content 216. This could be done to identify mentions of a company or entity within an instance of user submitted content 216, as well as usernames or metadata tags that have previously specified as selection criteria 223.

Next at block 309, the aggregator application 219 can add instances of the user submitted content 216 that match or contain a selection criterion 223 to the selected user submitted content 226. For example, the aggregator application 219 could add the user submitted content 216, including metadata associated with the user submitted content 216, to a list or array representing the selected user submitted content 236. The metadata could include information such as the number of times a post was shared or was liked, approved, or upvoted by another user.

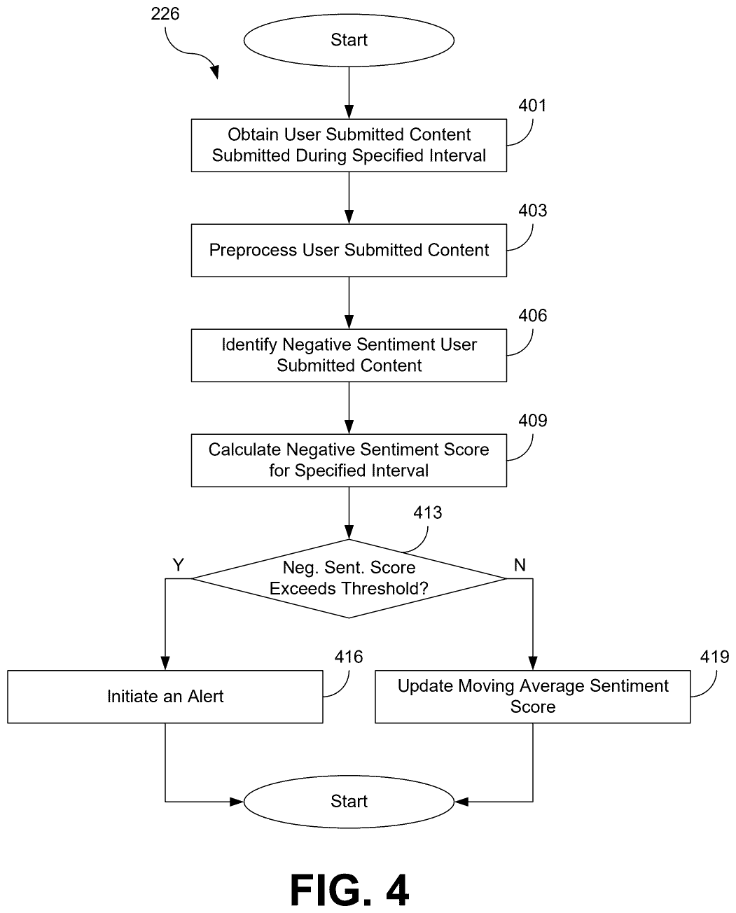

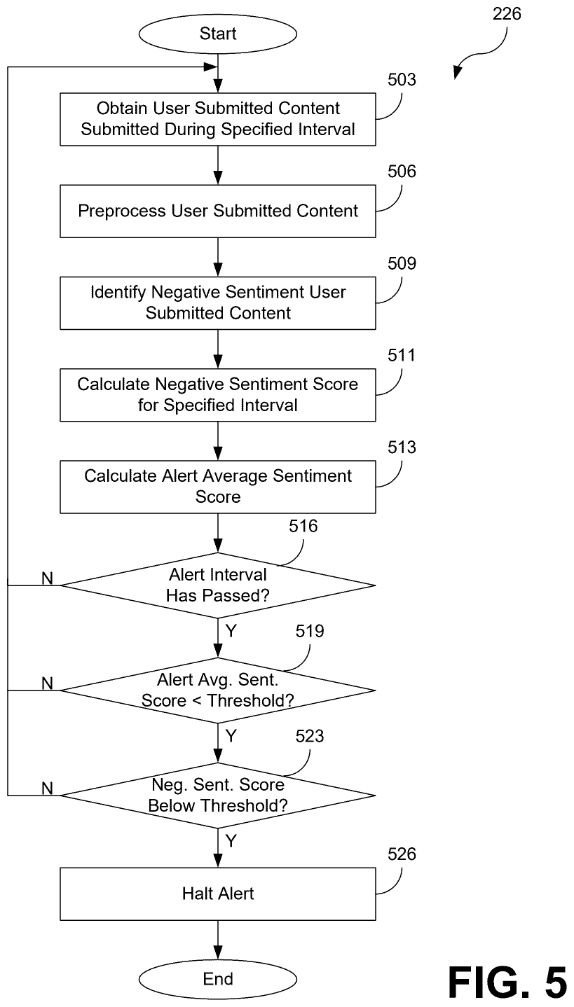

Finally, at block 313, the aggregator application 219 can provide the selected user submitted content 236 to the content analysis application 226. For example, the aggregator application 219 could send the selected user submitted content 236 across the network 213 to the content analysis application 226. The content analysis application 226 can then use the selected user submitted content 236 identified by the aggregator application 219 to determine whether an issue or a topic discussed on the social media platform 203 is increasing in visibility or awareness (e.g., “going viral”), as described in further detail in FIGS. 4 and 5.

Referring next to FIG. 4, shown is a flowchart that provides one example of the operation of a portion of the content analysis application 226. The flowchart of FIG. 4 provides merely an example of the many different types of functional arrangements that can be employed to implement the operation of the depicted portion of the content analysis application 226. As an alternative, the flowchart of FIG. 4 can be viewed as depicting an example of elements of a method implemented within the network environment 200.

Beginning with block 401, the content analysis application 226 can obtain one or more instances of selected user submitted content 236, such as social media posts made during a specified interval of time matching one or more of the selection criteria 223. These instances of selected user submitted content 236 can be received from or provided by the aggregator application 219 according to the various embodiments of the present disclosure, such as those previously discussed with respect to FIG. 3.

At block 403, the content analysis application 226 can then preprocess the selected user submitted content 236 received from the aggregator application 219. This can include removing images, videos, audio, or other media files from individual instances of the selected user submitted content 236, if present. This can also include removing uniform resource locators (URLs) or hypertext markup language (HTML) tags included in individual instances of the selected user submitted content 236, if present. As a result of the preprocessing, each instance of the selected user submitted content 236 obtained or received at block 401 will be in plaintext format for subsequent analysis.

Next at block 406, the content analysis application 226 can identify each of the selected instances of user submitted content 236 (e.g., selected instances of social media posts, tweets, etc.) that has a negative sentiment. For example, the content analysis application 226 could provide each instance of the selected user submitted content 236 to the sentiment analyzer 229. This can include “posts” or “tweets” (depending on the terminology of the particular social media platform 203) as well as replies to the posts or tweets as the replies can be considered to be posts or tweets in and of themselves.

The sentiment analyzer 229 can then use various sentiment analysis techniques to identify the subset of the selected user submitted content 236 that have a negative sentiment. For example, the sentiment analyzer 229 could use a previously trained machine-learning model to classify the selected user submitted content 236 based on sentiment (e.g., positive sentiment, neutral sentiment, negative sentiment, etc.). The sentiment analyzer 229 can then return the subset of the selected user submitted content 236 that has a negative sentiment to the content analysis application 226. The negative sentiment user content could be returned in the form of a list, an array, or other data structure.

Then at block 409, the content analysis application 226 can calculate a negative sentiment score 239 for the interval of time from which the selected user submitted content 236 was retrieved. For example, the content analysis application 226 could sum the total number of instances of selected user submitted content 236 that the sentiment analyzer 229 determined to have a negative sentiment at block 406. Moreover, the content analysis application 226 could add to the sum the total number of times an instance of selected user submitted content 236 with a negative sentiment was liked by another user of the social media platform 203 or shared, reshared, retweeted, etc. by another user of the social media platform 203. Using TWITTER® as an example social media platform 203, the negative sentiment score 239 could be calculated using the following formula:

Negative Sentiment Score=(Total Tweets with Negative Sentiment)+(Total Likes of Tweets with Negative Sentiment)+(Total Reshares of Tweets with Negative Sentiment).

However, other formulas taking other factors into account may also be used according to the particular characteristics of specific social media platforms 203 and the goals of the various implementations of the present disclosure.

Moving on to block 413, the content analysis application 226 can determine whether the negative sentiment score 239 calculated at block 409 exceeds a predefined, prespecified, or other threshold amount or value. Different thresholds may be used according to various implementations of the present disclosure. For example, a simple implementation might evaluate whether the negative sentiment score 239 is greater than a predefined value or amount. Similarly, an implementation of the content analysis application 226 might evaluate whether the negative sentiment score 239 is greater than a moving or regularly updated value, such as whether the negative sentiment score 239 is greater than at least one standard deviation of the moving average sentiment score 243.

As another example, an implementation might determine whether the current negative sentiment score 239 has exceeded at least one standard deviation of the moving average sentiment score 243 for several consecutive intervals or period of time. For example, the content analysis application 226 could be configured to determine if the current negative sentiment score 239 exceed at least one standard deviation of the moving average sentiment score 243 for two or more consecutive intervals of time, according to various implementations. For instance, if the process depicted in FIG. 4 were repeatedly performed, and the current negative sentiment score 239 exceeded the moving average sentiment score 243 in several consecutive performances, then the content analysis application 226 might conclude that the negative sentiment score 239 exceeds the threshold.

If the negative sentiment score 239 exceeds the threshold, then the content analysis application 226 proceeds to block 416. Assuming that the process proceeds to block 416, the content analysis application 226 can generate or initiate an alert that an issue or a topic discussed on the social media platform 203 is increasing in visibility or awareness (e.g., “going viral”). For example, the content analysis application 226 could send an email to a predefined mailbox, a short message service (SMS) message to a predefined recipient, or cause a notification to appear in a web portal or web application used by a particular individual or group of individuals.

For instance, in some implementations, the content analysis application 226 could generate an alert in response to a determination that the negative sentiment score 239 exceeds the moving average sentiment score 243 by the predefined value or amount. The alert could include the negative sentiment score 239 and the moving average sentiment score 243. The content analysis application 226 could then format the alert according to a recipient defined format or preference. For example, if the recipient has requested that the alert be delivered by SMS, the content analysis application 226 could format the alert to fit within the data allotment for SMS messages and format the alert to display appropriately on a mobile device. As another example, if the recipient has requested that the alert be delivered by email, the content analysis application 226 could format the alert to correctly display within an email client. Likewise, if the recipient has requested that the alert be delivered to an application executing on the client device of the recipient, then the content analysis application 226 to correctly display within the window or display area of the client application.

Once formatted, the content analysis application 226 could then transmit the alert to the client device of the recipient. When received by the client device, the alert could activate a client application executing on the client device to cause the client application to display the alert. The alert, when received by the client device, could also enable the client device or a client application executing on the client device to connect to the analysis system 209 or the content analysis application 226 to allow the client device or the client application to view additional information about the alert, such as the negative sentiment score 239, the moving average sentiment score 243, previous negative sentiment scores 239 from previous periods of time, etc.

However, if the negative sentiment score 239 fails to exceed the threshold, then the content analysis application 226 proceeds to block 419. Assuming that the process proceeds to block 419, the content analysis application 226 can update the moving average sentiment score 243 with the current negative sentiment score 239.

Referring next to FIG. 5, shown is a flowchart that provides one example of the operation of a portion of the content analysis application 226. The flowchart of FIG. 5 provides merely an example of the many different types of functional arrangements that can be employed to implement the operation of the depicted portion of the content analysis application 226. As an alternative, the flowchart of FIG. 5 can be viewed as depicting an example of elements of a method implemented within the network environment 200.

Beginning with block 503, the content analysis application 226 can obtain one or more instances of selected user submitted content 236, such as social media posts made during a specified interval of time matching one or more of the selection criteria 223. These instances of selected user submitted content 236 can be received from or provided by the aggregator application 219 according to the various embodiments of the present disclosure.

Next at block 506, the content analysis application 226 can then preprocess the selected user submitted content 236 received from the aggregator application 219. This can include removing images, videos, audio, or other media files from individual instances of the selected user submitted content 236, if present. This can also include removing uniform resource locators (URLs) or hypertext markup language (HTML) tags included in individual instances of the selected user submitted content 236, if present. As a result of the preprocessing, each instance of the selected user submitted content 236 obtained or received at block 401 will be in plaintext format for subsequent analysis.

Then at block 509, the content analysis application 226 identify each of the selected instances of user submitted content 236 (e.g., selected instances of social media posts, tweets, etc.) that has a negative sentiment. For example, the content analysis application 226 could provide each instance of the selected user submitted content 236 to the sentiment analyzer 229. This can include not only “posts” or “tweets” (depending on the terminology of the particular social media platform 203), but also replies to the posts or tweets as the replies can be considered to be posts or tweets in and of themselves.

The sentiment analyzer 229 can then use various sentiment analysis techniques to identify the subset of the selected user submitted content 236 that have a negative sentiment. The sentiment analyzer 229 can then return the subset of the selected user submitted content 236 that has a negative sentiment to the content analysis application 226. The negative sentiment user content could be returned in the form of a list, an array, or other data structure.

Proceeding to block 511, the content analysis application 226 can calculate a negative sentiment score 239 for the interval of time from which the selected user submitted content 236 was retrieved. For example, the content analysis application 226 could sum the total number of instances of selected user submitted content 236 that the sentiment analyzer 229 determined to have a negative sentiment at block 406. Moreover, the content analysis application 226 could add to the sum the total number of times an instance of selected user submitted content 236 with a negative sentiment was liked by another user of the social media platform 203 or shared, reshared, retweeted, etc. by another user of the social media platform 203. Using TWITTER® as an example social media platform 203, the negative sentiment score 239 could be calculated using the following formula:

Negative Sentiment Score=(Total Tweets with Negative Sentiment)+(Total Likes of Tweets with Negative Sentiment)+(Total Reshares of Tweets with Negative Sentiment).

However, other formulas taking other factors into account may also be used according to the particular characteristics of specific social media platforms 203 and the goals of the various implementations of the present disclosure.

Moving on to block 513, the content analysis application 226 can calculate the alert average sentiment score 246. For example, the alert average sentiment score 246 can be used to represent a moving average of the negative sentiment score 239 since an alert was initiated or triggered at block 416 as previously described in the discussion of FIG. 4. Accordingly, the moving average represented by the alert average sentiment score 246 could be recalculated to account for the negative sentiment score 239 calculated at block 511 for the latest interval of time.

Subsequently at block 516, the content analysis application 226 can determine whether an alert interval has passed. The alert interval can represent a minimum amount of time that should elapse before the content analysis application 226 begins to evaluate whether the issue or topic that triggered the alert on the social media platform 203 is continuing to increase in visibility or awareness (e.g., continuing to “go viral”). For example, an alert interval of one hour, six hours, twelve hours, twenty-four hours, etc. could be used according to particular implementations of the present disclosure. Once the alert interval has passed, then the content analysis application 226 can proceed to block 519. If the alert interval has not yet passed, then the process can return to block 503 and repeat for the subsequent predefined interval or period time.

Next at block 519, the content analysis application 226 can determine whether the alert average sentiment score 246 is less than a predefined value or threshold. This check can be performed to determine whether the rate at which the selected user submitted content 236 with a negative sentiment appearing on the social media platform 203 has decreased to an acceptable level. In some implementations, the threshold may required that the alert average sentiment score 246 be below the threshold for one or more consecutive intervals or periods of time. This may be done to determine that the decreasing rate at which negative sentiment content is being submitted to the social media platform 203 is a sustained decrease. If the alert average sentiment score 246 is less than the predefined threshold or value, then the process can proceed to block 523. Otherwise, the process can return to block 503 and repeat for the subsequent predefined interval or period time.

Then at block 523, the content analysis application 226 can determine whether the current negative sentiment score 239 calculated at block 511 is less than a predefined value or threshold. For example, the content analysis application 226 could determine whether the current negative sentiment score 239 is less than a threshold value that is based at least in part on the moving average sentiment score 243 prior to the initiation of the alert at block 416. For instance, the content analysis application 226 could determine whether the current negative sentiment score 239 is within one or more standard deviations of the moving average sentiment score 243. This could be done in order to confirm that the number instances of selected user submitted content 236 with a negative sentiment is in line with historical or normal levels. If the current negative sentiment score 239 calculated at block 511 is less than a predefined value or threshold, then the process proceeds to block 526. Otherwise, the process can return to block 503 and repeat for the subsequent predefined interval or period time.

Moving on to block 526, the content analysis application 226 can halt the alert triggered or initiated at block 416 of FIG. 4. For example, the content analysis application 226 could send a subsequent email or SMS message to indicate that the issue or a topic discussed on the social media platform 203 is no longer increasing in visibility or awareness (e.g., it is no longer “going viral”). Likewise, if a message was previously being displayed in a web portal or web application, the message may cease to be displayed.

A number of software components previously discussed are stored in the memory of the respective computing devices and are executable by the processor of the respective computing devices. In this respect, the term “executable” means a program file that is in a form that can ultimately be run by the processor. Examples of executable programs can be a compiled program that can be translated into machine code in a format that can be loaded into a random access portion of the memory and run by the processor, source code that can be expressed in proper format such as object code that is capable of being loaded into a random access portion of the memory and executed by the processor, or source code that can be interpreted by another executable program to generate instructions in a random access portion of the memory to be executed by the processor. An executable program can be stored in any portion or component of the memory, including random access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory includes both volatile and nonvolatile memory and data storage components. Volatile components are those that do not retain data values upon loss of power. Nonvolatile components are those that retain data upon a loss of power. Thus, the memory can include random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random access memory (SRAM), dynamic random access memory (DRAM), or magnetic random access memory (MRAM) and other such devices. The ROM can include a programmable read-only memory (PROM), an erasable programmable read-only memory (EPROM), an electrically erasable programmable read-only memory (EEPROM), or other like memory device.

Although the applications and systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts show the functionality and operation of an implementation of portions of the various embodiments of the present disclosure. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although the flowcharts show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the flowcharts can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e.g, storage area networks or distributed or clustered filesystems or databases) may also be collectively considered as a single non-transitory computer-readable medium.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random access memory (RAM) including static random access memory (SRAM) and dynamic random access memory (DRAM), or magnetic random access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices in the same computing environment.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X, Y, or Z). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

1. A system, comprising:
a computing device comprising a processor and a memory; and
machine-readable instructions stored in the memory that, when executed by the processor, cause the computing device to at least:
train a machine learning model for sentiment analysis of a plurality of social media posts based at least in part on applying a machine learning algorithm to a training data set that comprises a sample text in a format of a respective social media platform, the machine learning model being trained to classify a respective social media post as at least one of positive, negative, or neutral;
identify an expiration of a predefined interval of time for obtaining user submitted content from a social media platform site;
preprocess the user submitted content by removing a media file from a plurality of user posts to generate a plurality of modified user posts in a plaintext format;
determine a negative sentiment score of a subset of posts with a negative sentiment based at least in part on the plurality of modified user posts, wherein the negative sentiment score is calculated by performing the sentiment analysis on the plurality of modified user posts to identify the subset of posts with the negative sentiment based at least in part on the machine learning model;
determine the negative sentiment score exceeds a first moving average sentiment score;
generate an alert in response to the determination that the negative sentiment score exceeds the first moving average sentiment score;
format the alert according to a defined format of a recipient;
transmit the alert to a client device associated with the recipient, wherein the alert activates a client application executing on the client device to cause the client application to display the alert and to enable the client device to connect to the computing device across a network to view additional information about the alert; and
halt the alert at the client device by instructing the client device to cease to display the alert on the client device based at least in part on a second moving average sentiment score that is less than a respective threshold value associated with the first moving average sentiment score.

2. The system of claim 1, wherein the first moving average sentiment score is a moving average of the negative sentiment score for a defined preceding time period.

3. The system of claim 1, wherein the machine-readable instructions that cause the computing device to determine the negative sentiment score further causes the computing device to at least:
for each post in the subset of posts with the negative sentiment, identify a number of reposts the post and a number of likes associated with the post; and
calculate a sum of the posts in the subset of posts with the negative sentiment and the number of reposts and the number of likes associated each post in the subset of posts with the negative sentiment, wherein the sum represents the negative sentiment score.

4. The system of claim 1, wherein the machine-readable instructions that halt the alert at the client device by instructing the client device to cease to display the alert further cause the computing device to at least:
determine an alert time interval has passed since the transmission of the alert to the client device; and
compare the first moving average sentiment score to the second moving average sentiment score to determine whether the second moving average sentiment score is less than a threshold value that is based at least in part on the first moving average sentiment score.

5. The system of claim 1, wherein the machine-readable instructions that halt the alert at the client device further cause the computing device to at least:
in response to the alert being triggered, calculate the second moving average sentiment score, the second moving average sentiment score representing a moving average of the negative sentiment score since the alert was initiated; and
compare the first moving average sentiment score to the second moving average sentiment score to determine whether the second moving average sentiment score is less than a threshold value that is based at least in part on the first moving average sentiment score.

6. The system of claim 1, wherein the machine-readable instructions that halt the alert at the client device by instructing the client device to cease to display the alert further cause the computing device to at least:
recalculate the negative sentiment score for the subset of posts associated with the social media platform within the predefined interval of time;
compare the recalculated negative sentiment score to the first moving average sentiment score to determine whether the recalculated negative sentiment score is less than the threshold value, the threshold value being based at least in part on the first moving average sentiment score.

7. The system of claim 6, wherein the alert is halted by further causing the computing device to at least:
transmit a subsequent email or a subsequent SMS message to the client device associated with the recipient.

8. A computer-implemented method, comprising:
training, by at least one computing device, a machine learning model for sentiment analysis of a plurality of social media posts based at least in part on applying a machine learning algorithm to a training data set that comprises a sample text in a format of a respective social media platform, the machine learning model being trained to classify a respective social media post as at least one of positive, negative, or neutral;
removing, by the at least one computing device, a media file from a plurality of user posts to generate a plurality of modified user posts in a plaintext format;
calculating, by the at least one computing device, a negative sentiment score of a subset of posts with a negative sentiment based at least in part on the plurality of modified user posts, wherein the negative sentiment score is calculated by performing the sentiment analysis on the plurality of modified user posts to identify the subset of posts with the negative sentiment based at least in part on the machine learning model;
determining, by the at least one computing device, the negative sentiment score exceeds a first moving average sentiment score;
generating, by the at least one computing device, an alert in response to the determination that the negative sentiment score exceeds the first moving average sentiment score;
formatting, by the at least one computing device, the alert according to a defined format of a recipient; and
transmitting, by the at least one computing device, the alert to a client device associated with the recipient, wherein the alert activates a client application executing on the client device to cause the client application to display the alert and to enable the client device to connect to the at least one computing device across a network to view additional information about the alert; and
halting, by the at least one computing device, the alert at the client device by instructing the client device to cease to display the alert on the client device based at least in part on a second moving average sentiment score that is less than a respective threshold value associated with the first moving average sentiment score.

9. The computer-implemented method of claim 8, wherein the first moving average sentiment score is a moving average of the negative sentiment score for a defined preceding time period.

10. The computer-implemented method of claim 8, wherein calculating the negative sentiment score further comprises:
for each post in the subset of posts with the negative sentiment, identifying, by the at least one computing device, a number of reposts the post and a number of likes associated with the post; and
calculating, by the at least one computing device, a sum of the posts in the subset of posts with the negative sentiment and the number of reposts and the number of likes associated each post in the subset of posts with the negative sentiment, wherein the sum represents the negative sentiment score.

11. The computer-implemented method of claim 8, wherein halting the alert at the client device by instructing the client device to cease to display the alert further comprises:
determining, by the at least one computing device, an alert time interval has passed since the transmission of the alert to the client device; and
comparing, by the at least one computing device, the first moving average sentiment score to a second moving average sentiment score to determine whether the second moving average sentiment score is less than a threshold value that is based at least in part on the first moving average sentiment score.

12. The computer-implemented method of claim 8, wherein halting the alert at the client device by instructing the client device to cease to display the alert further comprises:
in response to the alert being triggered, calculating, by the at least one computing device, a second moving average sentiment score, the second moving average sentiment score representing a moving average of the negative sentiment score since the alert was initiated; and
comparing, by the at least one computing device, the first moving average sentiment score to the second moving average sentiment score to determine whether the second moving average sentiment score is less than a threshold value that is based at least in part on the first moving average sentiment score.

13. The computer-implemented method of claim 8, wherein halting the alert at the client device by instructing the client device to cease to display the alert further comprises:
recalculating, by the at least one computing device, the negative sentiment score for the subset of posts associated with the social media platform within a predefined interval of time; and
comparing, by the at least one computing device, the recalculated negative sentiment score to the first moving average sentiment score to determine whether the recalculated negative sentiment score is less than the threshold value, the threshold value being based at least in part on the first moving average sentiment score.

14. The computer-implemented method of claim 13, wherein the alert is halted by the method further comprising:
transmitting, by the at least one computing device, a subsequent email or a subsequent SMS message to the client device associated with the recipient.

15. A non-transitory, computer-readable medium, comprising machine-readable instructions that, when executed by a processor of a computing device, cause the computing device to at least:
train a machine learning model for sentiment analysis of a plurality of social media posts based at least in part on applying a machine learning algorithm to a training data set that comprises a sample text in a format of a respective social media platform, the machine learning model being trained to classify a respective social media post as at least one of positive, negative, or neutral;
remove a media file from a plurality of user posts to generate a plurality of modified user posts in a plaintext format;
determine a negative sentiment score of a subset of posts with a negative sentiment based at least in part on the plurality of modified user posts, wherein the negative sentiment score is calculated by performing the sentiment analysis on the plurality of modified user posts to identify the subset of posts with the negative sentiment based at least in part on the machine learning model;
determine the negative sentiment score exceeds a first moving average sentiment score;
generate an alert in response to the determination that the negative sentiment score exceeds the first moving average sentiment score;
format the alert according to a defined format of a recipient;
transmit the alert to a client device associated with the recipient, wherein the alert activates a client application executing on the client device to cause the client application to display the alert and to enable the client device to connect to the computing device across a network to view additional information about the alert; and
halt the alert at the client device by instructing the client device to cease to display the alert on the client device based at least in part on a second moving average sentiment score that is less than a respective threshold value associated with the first moving average sentiment score.

16. The non-transitory, computer-readable medium of claim 15, wherein the first moving average sentiment score is a moving average of the negative sentiment score for a defined preceding time period.

17. The non-transitory, computer-readable medium of claim 15, wherein the machine-readable instructions that cause the computing device to determine the negative sentiment score further cause the computing device to at least:
for each post in the subset of posts with the negative sentiment, identify a number of reposts the post and a number of likes associated with the post; and
calculate a sum of the posts in the subset of posts with the negative sentiment and the number of reposts and the number of likes associated each post in the subset of posts with the negative sentiment, wherein the sum represents the negative sentiment score.

18. The non-transitory, computer-readable medium of claim 15, wherein and the machine-readable instructions that halt the alert at the client device by instructing the client device to cease to display the alert further cause the computing device to at least:
determine an alert time interval has passed since the transmission of the alert to the client device; and
compare the first moving average sentiment score to a second moving average sentiment score to determine whether the second moving average sentiment score is less than a threshold value that is based at least in part on the first moving average sentiment score.

19. The non-transitory, computer-readable medium of claim 15, wherein the machine-readable instructions that halt the alert at the client device by instructing the client device to cease to display the alert further cause the computing device to at least:
in response to the alert being triggered, calculate a second moving average sentiment score, the second moving average sentiment score representing a moving average of the negative sentiment score since the alert was initiated; and
compare the first moving average sentiment score to the second moving average sentiment score to determine whether the second moving average sentiment score is less than a threshold value that is based at least in part on the first moving average sentiment score.

20. The non-transitory, computer-readable medium of claim 15, wherein the machine-readable instructions that halt the alert at the client device by instructing the client device to cease to display the alert further cause the computing device to at least:
recalculate the negative sentiment score for the subset of posts associated with the social media platform within a predefined interval of time; and
compare the recalculated negative sentiment score to the first moving average sentiment score to determine whether the recalculated negative sentiment score is less than the threshold value, the threshold value being based at least in part on the first moving average sentiment score.
